(19) United States
(12) Patent Application Publication
(10) Pub. No.: US 2005/0275178 A1
(43) Pub. Date: Dec. 15, 2005

(54) Mobile modular stand

(76) Inventors: Douglas Huesdash, Allendale, MI (US); Timothy Stern, Ada, MI (US)

Correspondence Address: MCKELLAR IP LAW, PLLC, 784 SOUTH POSEYVILLE ROAD, MIDLAND, MI, 48640, US

(21) Appl. No.: 11/148,585

(22) Filed: Jun. 9, 2005

Related U.S. Application Data
(60) Provisional application No. 60/578,601, filed on Jun. 10, 2004.

(51) Int. Cl. B62B 3/00

(52) U.S. Cl. 280/47.35

(57) ABSTRACT

Modular component mobile support stand and various accessories and a system of modular components to provide mobility and support for countless applications. The modular component mobile support stand has the capability of being disassembled and assembled without the use of tools and this capability allows for the interchangeability of the various modular accessory components.

This application claims priority from U.S. Provisional 60/578,601 filed Jun. 10, 2004.

### BACKGROUND OF THE INVENTION AND PRIOR ART

This invention deals with a modular component mobile support stand and various accessories. This invention also deals with a system of modular components to provide mobility and support for countless applications.

There are many patents dedicated to modular storage units and/or mobility of the same and those known to the applicants herein are, for example, U.S. Pat. No. 5,566,961, that issued on Oct. 22, 1996 to Snell, et al in which there is described a modular storage that includes a plurality of shelf components having a bottom portion and which are enabled to be converted into cabinets. This device is simple a carrier table for such elements and is designed to be only a storage capability.

U.S. Pat. No. 6,497,423 that issued on Dec. 24 2002 to Perelli, et al deals with a mobile maintenance cart having storage shelves and a container storage attached to the back end of said cart. This cart is designed to carry maintenance materials and collect rubbish and the like.

U.S. Pat. No. 6,493,220 that issued on Dec. 10, 2002 to Clark, et al deals with a mobile clinical workstation that includes an adjustable height horizontal tray and a pull-out keyboard tray that is mounted beneath the horizontal tray to support a keyboard. In addition, there is a power source mounted in the bottom of the cart.

U.S. Pat. No. 6,493,217 that issued Dec. 10, 2002 to Jenkins deals with a mobile workstation with power supply system in which there is shown a base mounted on castors, a vertical column that is attached to the base, and a shelf that is mounted to the top most end of the column. The shelf supports a computer or the like.

U.S. Pat. No. 6,721,178 that issued on Apr. 13, 2004 to Clark, et al, also deals with a mobile clinical workstation. This patent is a continuation of the '220 patent and thus the description is identical therein.

### BRIEF DESCRIPTION OF THE DRAWINGS

FIG. 1 is a full view in perspective of the mobile modular support stand of this invention.

FIG. 2A is a view in perspective of the base of the invention.

FIG. 2B is a view in perspective of the base of the invention showing the approximate angle of the intersection of the forward extending support members.

FIG. 3A is a full side view of two of the cantilevered support members.

FIG. 3B is a full back view of a portion of a support bar of the lattice.

FIG. 4 is a full top view of a cantilevered support member.

FIG. 5 is top view in perspective of a device of this invention wherein the lattice is enclosed with a storage space.

FIG. 6 is an enlarged exploded view of FIG. 5.

FIG. 7 a view in perspective of a system of this invention wherein there is shown a shelf, a desk top and a drawing board along with an enclosed storage space around the lattice.

FIG. 8 is a view in perspective of a system of this invention showing four shelves in a stacked position.

FIG. 9 is a view in perspective of a system of this invention showing a cabinet and a shelf configuration.

FIG. 10 is a view in perspective of a system of this invention showing a cabinet with two front doors and a third leg therebetween.

### THE INVENTION

This invention deals with a modular component mobile support stand and various accessories. This invention also deals with a system of modular components to provide mobility and support for countless applications.

Thus, this invention deals with a modular component mobile support stand comprising a base, wherein the base is supported by at least four casters. There is a vertical lattice having a top end and a bottom end, the vertical lattice being affixed to the base by its bottom end, and there are at least two cantilever brackets detachably affixed to the vertical lattice for supporting accessories.

This invention also deals in another embodiment with modular component mobile support stands having multiple accessories, such as simple platforms, elevatable desk tops, video screens, flat monitor brackets, open cabinets, closed cabinets, hanging file storage, audio/visual storage and transporting, health care applications, mobile laptop work desks, seating, podiums, electrical accessories, power sources, power strips, data strips, cord management, paper management trays, wireless data transmitters and receivers, to name a few.

Yet another embodiment of this invention is a novel base for a modular component mobile support stand, the base comprising an essentially U-shaped main cross bar to which is attached two forward extending support legs, wherein the each of the forward extending support legs has a front end and a back end and the back ends are attached to the U-shaped main cross bar.

Still another embodiment of this invention is a novel cantilevered support member, said cantilevered support member having a near end, the near end having an extension mounted thereon, said extension terminating in an L-shaped configuration, said L-shaped configuration having an inside surface, the L portion of the extension having a tooth centered on the inside surface. The cantilevered support member also features a pivoting cam located at the junction of the near end of the cantilevered support member and the attachment of the L-shaped configuration and on the top surface of the cantilevered support member for locking the cantilevered support member into the legs of the vertical lattice.

There is also an embodiment that is a kit, said kit comprising in combination, a. a base member; b. four transport devices; c. four bumper disks; d. at least one vertical lattice; e. at least two cantilever support members, and, f at least one accessory module selected from the group consisting of (i) desk top, (ii) personal computer, (iii) film projector, (iv) slide projector, (iv) television, (v) DVD player, (vi) tape recorder, (vii) overhead projector, (viii) cupboard, (ix) typewriter, (x) keyboard, (xi) bookshelf, (xii) power pack (xiii) printer, (xiv) scanner, (xv) lighting, (xvi) simple platforms, (xvii) video screens, (xviii) flat monitor brackets, (xix) hanging file storage, (xx) audio/visual storage and transporting, (xxi) health care appliances, (xxii) mobile laptop work desks, (xxiii) seating, (xxiv) podiums, (xxv) electrical accessories, (xxvi) power sources, (xxvii) power strips, (xxviii) data strips, (xxix) cord management, (xxx) paper management trays, (xxxi) wireless data transmitters, (xxxii) wireless data receivers, and any combination of (i) to (xxxii).

### DETAILED DESCRIPTION OF THE INVENTION

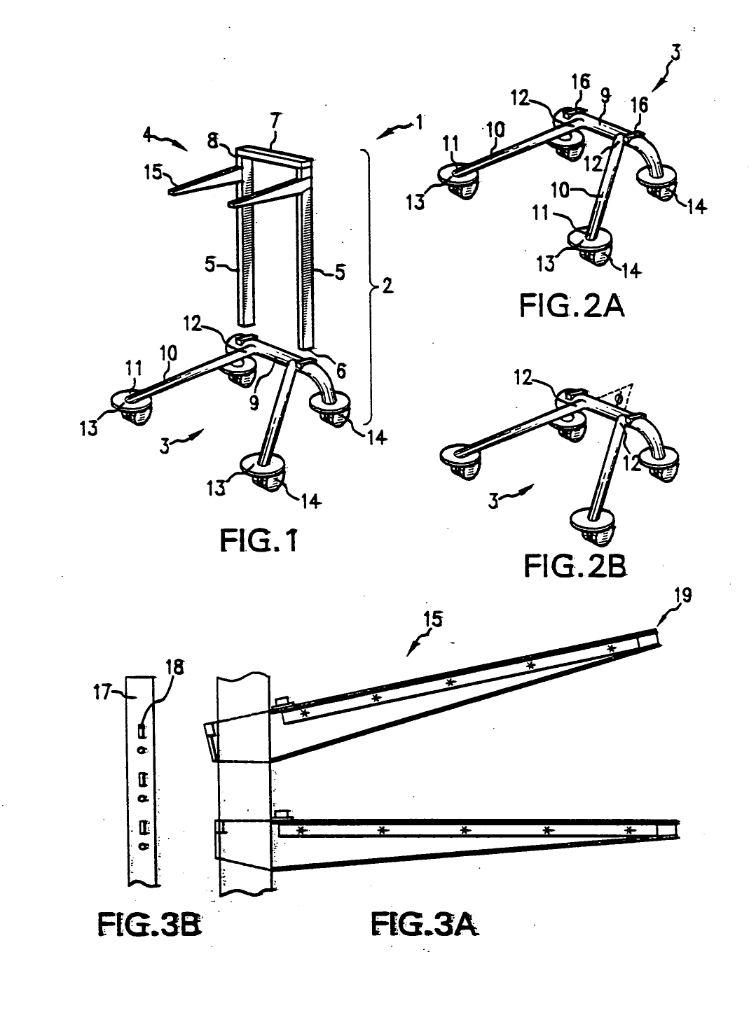

Turning now to a detailed description of the invention, there is shown in FIG. 1 a full view in perspective of the mobile modular support stand 1 of this invention wherein there is shown a chassis 2 comprised of two main components, a base 3, and a lattice column 4. The base 3 is comprised of an essentially U-shaped main cross bar 9, to which is attached to forward extending support legs 10. It should be noted that the two forward extending support legs 10 are angled away from each other such that the front ends 11 of the base 3 are farther apart than the back ends 12. This arrangement of the support for the base 3 tends to provide support for the chassis 2 that is not possible with equally spaced-apart support members such as are found, for example, in U.S. Pat. No. 6,721,178, U.S. Pat. No. 6,493,217, and U.S. Pat. No. 5,493,220 discussed Supra.

It should be noted that the base 3 is constructed such that the support provided by the U-shaped main cross bar 9 in cooperation with the forward extending support legs 10 is provided by a complex angle of such components, in both the vertical and horizontal dimensions. If the linear axis lines of the forward extending support legs 10 were extended beyond the back ends 12 as shown in phantom in FIG. 2B, the angle φ would be on the order of about 35° to about 65°, with the preferred angle φ being on the order of about 45° to about 55°. This provides for the nesting of parts, maximizing the stability for large loads, provides visually dynamic mode enhancement of the unit and it minimizes the unit's visual mass. This construction allows for optimizing access to the contents of the unit, minimizing the utilities management capability and provides for desired visual characteristics. The base 3 transfers all load to the floor through the castors 14, which are designed to be oversize from the normal.

Attached to the ends 11 of each of the forward extending support legs 10, and the end of the U-shaped main cross bar 9 are rotatable castors or wheels 14. Each of these castors or wheels has the capability to rotate and to also roll such that the mobile modular support stand 1 has unique mobility and flexibility in steering when the mobile modular support stand is moved, and allows for ease of transport over uneven surfaces and thresholds, in and out of elevators, over rugs, and the like. In certain applications, the castors 14 can be replaced with glides. Also, this type of castor or wheel 14 is capable of being locked such that the mobile modular support stand 1 cannot be moved.

In addition, surmounted above each of the rotatable castors 14 is a bumper disk 13 that is manufactured out of materials that will enable them to absorb contact with other surfaces and prevent the mobile modular support stand 1 from being damaged. This type of bumper disk 13 also protects the walls and other objects in a building as the absorbent capability absorbs shocks that would normally damage such wall structures. In addition, the disk 13 provides a design detail that is not available with other mobile units. The disk 13 is large enough to extend beyond the caster or wheel radius to aid in the damage control aspects of the disk 13.

As can be viewed from FIG. 1, each of the legs 5 of the lattice column 4 are attached at their bottom ends 6 to the base 3 to obtain the chassis 2. It should be noted for purposes of this invention that this connection can be a permanent connection, or it can be a connection that is easily disconnected. For example, the legs 5 can be welded in place, or they can be inserted into cup-like retainers, or some other means of attaching/detaching the legs, such as pegs on the base and hollow legs that are insertable over them. In addition, it is contemplated within the scope of this invention that the bottoms of the legs can have insertable tabs, and that the base member, on the top surface can have a slot for receiving such insertable tabs. What is important is that such a connection can hold against the stress of heavy objects placed in storage or on shelves of the mobile modular support stand 1. The height of the lattice 4 is designed to accommodate low configurations such as stools, to intermediate heights such as casual seating, and high configurations such as for standing and for video screen support. Thus, the lattice 4 ranges in height from about 24 inches to about 58 inches, the preferred range being 28 inches to 52 inches. It should be noted that the devices of this invention are intended to be those that are capable of interchanging the accessory modules by removing the lattice entirely from the base and substituting another lattice that already has an another accessory module capability. For example, a lattice on a base that contains, for example, a moveable desk top, can be interchanged with a lattice that contains computer and computer capabilities.

Thus, there is shown in FIG. 1 the chassis 2, the base 3, the lattice column 4, the legs 5 of the lattice column 4, and in addition, there is shown a cross-bar 7 that holds the top ends 8 of the legs 5 in a solid position. It is contemplated within the scope of this invention to use cross-bars 7 that are removable from the tops of the legs so that the lattice can be broken down and packaged or transported and then can be reassembled.

Turning now to FIG. 2, that is a view in perspective of the base 3 of the invention showing the main crossbar 9, the forward extending legs 10, the front ends 11 of the forward extending legs 10, and the back ends 12 of the forward extending legs 10. In addition, there is shown two posts 16 that are configured such that each leg 5 of the lattice 4 can be placed down over the pegs 16, respectively, and hold the lattice 4 in place. This is another method by which legs 5 can be attached to the base 3. Yet another method of attaching the legs 5 of the lattice 4 to the base 3 is through the use of bolts and/or screws. It is contemplated within the scope of this invention to provide a modular component mobile support stand that can be easily and quickly assemble and disassembled so that tools are not required.

It can be noted from FIG. 1 that there is a pair of cantilever support members 15 that are detachedly affixed to the legs 5 of the lattice 4. The cantilever support members 15 are arranged on the legs 5 at any height that is desirable to accommodate the accessories that are being placed thereon.

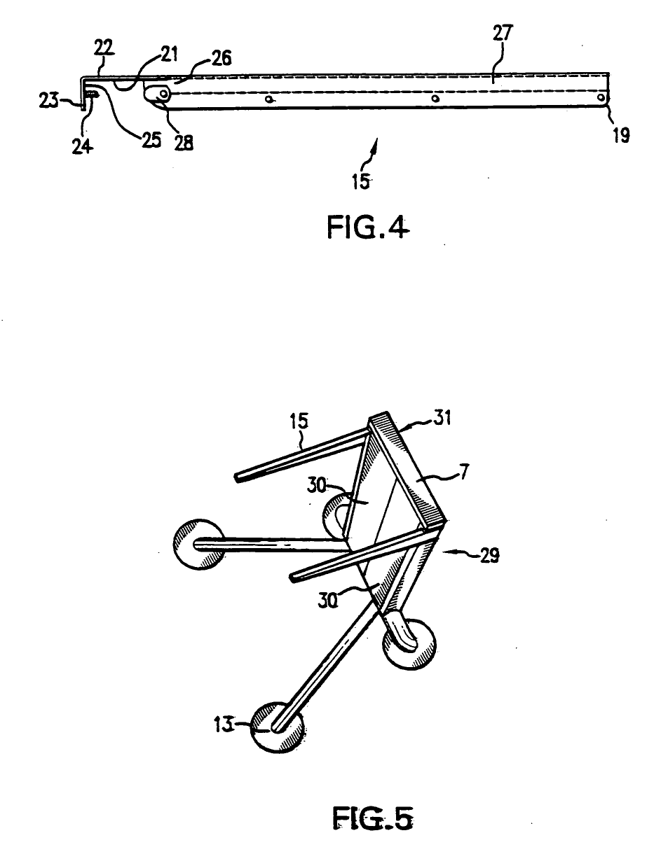

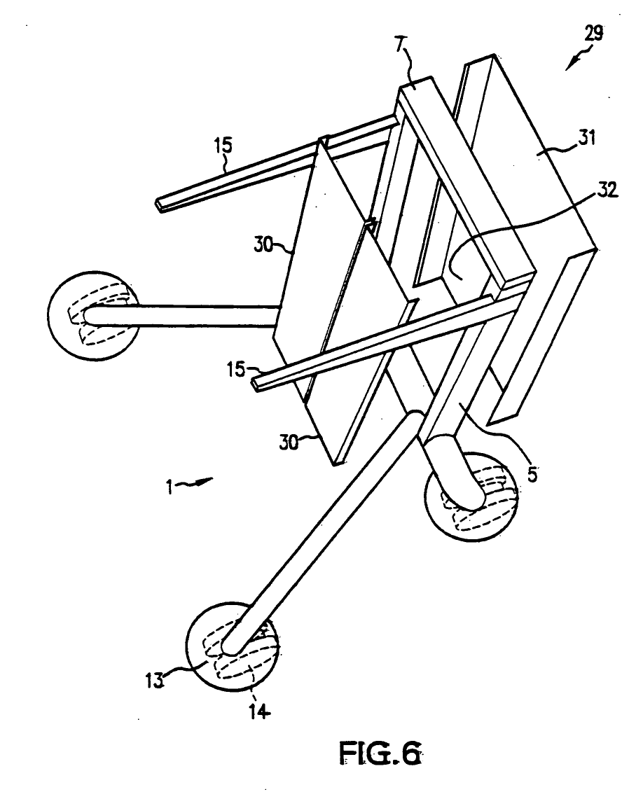

Cantilevered support members 15 are illustrated in FIG. 3A wherein the top cantilevered support member 15 is tilted upwardly at its distal end 19 and the bottom cantilevered support member 15 is fully engaged and located perpendicular to the leg 5. FIG. 4 is a full top view of a cantilever support member 15 of this invention in which there is shown the distal end 19 and the near end 20 of the cantilever support member 15. There is also shown near the near end 20, a gap 21 or opening that is the size of the outer diameter of a leg 5. At the near end 20 there is shown an extension 22 of the cantilever support member 15 that is used to attach the cantilever support member to the leg 5. The extension 22 terminates in an L-shaped extension 23 that has a tooth 24 positioned vertical to the inside surface 25 of the L-shaped extension 23. The cantilever support members 15 are useful in many sizes, for example, larger, heavier members 15 for large loads, and smaller, lighter members 15 for smaller, lighter loads.

The back surface 17 of the legs 5 can be found in FIG. 3B. Therein are shown slots 18 into which the tooth 24 is inserted. Thus, in use, the cantilevered support member 15 can be moved up and down on the leg 5 by tilting the distal end 19 up slightly to dislocate the tooth 24 from the slot 18, the cantilevered support member 15 can then be moved up or down as desired, and then the distal end 19 is lowered to the horizontal and the tooth is inserted into the slot 18.

In order to prevent accidental dislodgements, a pivoting cam 26 is located near the gap 21 and on the top surface 27 of the cantilevered support member 15. The pivoting cam 26, when the lobe 28 is positioned toward the leg 5, disables an upward tilt of the distal end 19 of the cantilevered support member 15, and consequently the tooth 24 remains engaged in the slot 18 and the cantilevered support member 15 is locked to the leg 5. Similarly, when the lobe 28 of the pivoting cam 26 is positioned away from the leg 5, the distal end 19 of the cantilevered support member 15 can be tilted up and the cantilevered support member 15 is unlocked from the leg 5.

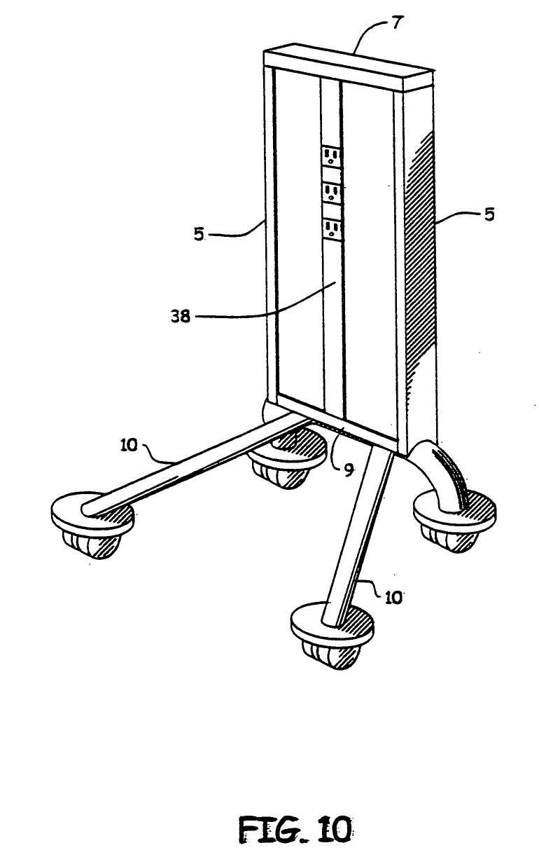

FIG. 5 is a top perspective view of a device of this invention showing the legs 5 enclosed with a casing 29. The casing 29 is comprised of two front fascia panels 30 and a rear fascia panel 31. It is contemplated that this casing 29 can be comprised of a single front fascia panel. Where two front fascia panels 30 are used, it is contemplated that they can be separated by yet another leg 38 (FIG. 10) that can have power outlets contained therein.

FIG. 6 is an exploded and enlarged view of FIG. 5 and wherein like numerals designate like components, there is shown the casing 29 with its component parts, front fascia panels 30 and back fascia panel 31. This casing 29 is designed in one embodiment to be clipped onto the lattice 4 and in another embodiment, it is designed to be firmly attached to the lattice 4.

The inside hollow cavity 32 provided by the casing 29 is provided by the assemblage of the various components, i.e. the lattice 4, the back fascia panel 31, and the front fascia panels 30, and provides a hollow cavity 32 housing a variety of functional accessories. The hollow area 32 can accommodate a power and data strip, cord management, paper management trays, wireless data transmitters and receivers, battery packs to power items being used on the mobile modular support stand 1. Access to the hollow cavity 32 can be achieved by accessing through the front fascia panels 30, or by removing the back fascia panel 31.

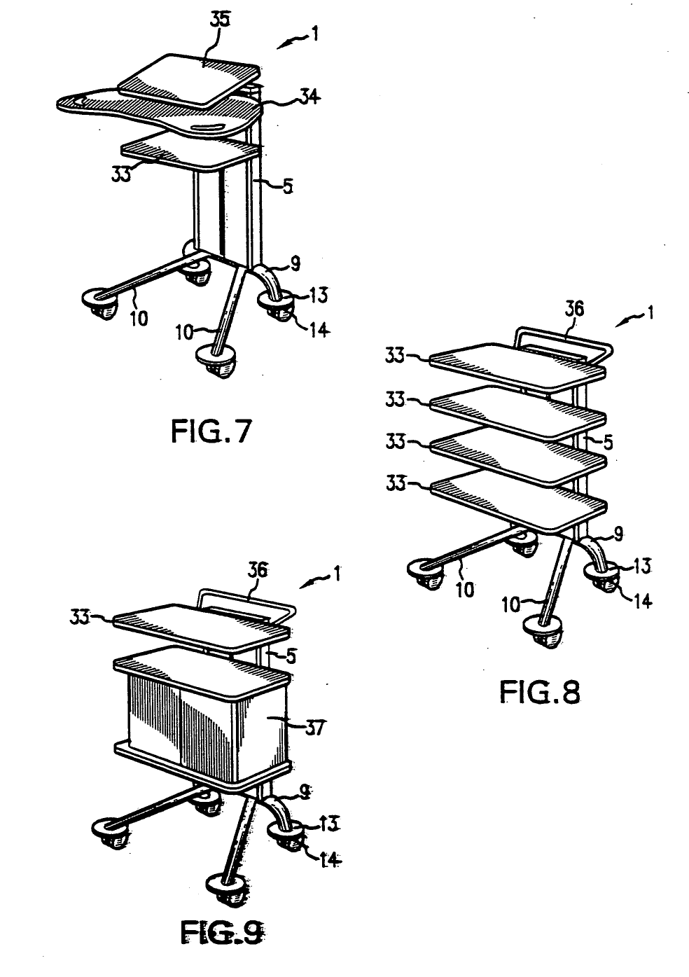

With reference to FIGS. 6, 7, and 8, there is shown therein various combinations of the accessories on individual mobile modular support stands 1. For example, in FIG. 7, there is shown a bottom shelf 33, a desk top 34, and an elevatable drawing board 35. It should be noted that this particular configuration, among others, allows for a stool or chair to be placed at the front of the mobile modular support stand 1.

Turning to FIG. 8, there is shown an arrangement of shelves 33 and the attachment of a handle 36 to the legs 5. In FIG. 9, there is shown a cabinet 37 and a shelf 33. The accessories can have many sizes and shapes and this is dependent on the intended end use of the device 1. The accessories can be manufactured from wood, veneer, laminated panels, painted panels, power coated materials, metals, fabric covered panels, and the like. Flat surfaces can be outfitted with top surface side rails to prevent materials and items from slipping and falling to the floor.

The device 1 can be compiled into a kit that can be pre-determined by the customer and the kit can be shipped to the customer for assembly.

1. A modular component mobile support stand comprising in combination:
a base, said base being supported by at least four transport devices;
a vertical lattice having a top end and a bottom end and said vertical lattice being affixed to the base at the bottom end, and
at least two cantilever support members detachably affixed to the vertical lattice.

2. The modular component mobile support stand as claimed in claim 1 wherein the base is comprised of an essentially U-shaped main cross bar to which is attached two forward extending support legs, wherein the each of the forward extending support legs has a front end and a back end and the back ends are attached to the U-shaped main cross bar.

3. The modular component mobile support stand as claimed in claim 2 wherein the front ends of the forward extending support legs are spaced apart from each other a greater distance that the back ends of the forward extending support legs are spaced from each other.

4. The modular component mobile support stand as claimed in claim 1 wherein the four transport devices are rotatable wheels.

5. The modular component mobile support stand as claimed in claim 4 wherein the rotatable wheels are lockable.

6. The modular component mobile support stand as claimed in claim 1 wherein the four transport devices are rotatable castors.

7. The modular component mobile support stand as claimed in claim 6 wherein the rotatable castors are lockable.

8. The modular component mobile support stand as claimed in claim 1 wherein the four transport devices are glides.

9. The modular component mobile support stand as claimed in claim 4 wherein each of the rotatable wheels is surmounted by a bumper disk.

10. The modular component mobile support stand as claimed in claim 6 wherein each of the rotatable castors is surmounted by a bumper disk.

11. The modular component mobile support stand as claimed in claim 5 wherein each of the rotatable wheels is surmounted by a bumper disk.

12. The modular component mobile support stand as claimed in claim 7 wherein each of the rotatable castors is surmounted by a bumper disk.

13. A modular component support stand as claimed in claim 1 wherein the lattice is detachedly mounted on the base member.

14. The modular component mobile support stand as claimed in claim 13 wherein the lattice is detachedly mounted to the base member, the base member having an upper surface and a mounting peg located on the upper surface, wherein the lattice has two hollow legs, and each leg of the lattice is aligned with each such mounting peg and is inserted over the mounting pegs.

15. The modular component mobile support stand as claimed in claim 13 wherein the lattice is detachedly mounted to the base member, the base member having an upper surface and a slot in the upper surface, the lattice having two legs, each leg having a mounting tab at the bottom end thereof, wherein each leg of the lattice is aligned with a slot on the upper surface of the base and is inserted therein.

16. The modular component mobile support stand as claimed in claim 13 wherein the lattice is detachedly mounted to the base member, the base member having an upper surface and a hollow cup secured on the upper surface, wherein the lattice has two legs with bottom ends that are insertable into the hollow cups.

17. The modular component mobile support stand as claimed in claim 14 wherein at least one hollow leg is secured to the mounting peg by a locking device.

18. A modular component mobile support stand as claimed in claim 17 wherein the locking device is a pin inserted through the leg and the mounting peg.

19. A modular component mobile support stand as claimed in claim 15 wherein at least one hollow leg tab is secured to the base by a locking device.

20. A modular component mobile support stand as claimed in claim 19 wherein the locking device is a pin inserted through the base and the mounting tab.

21. A modular component mobile support stand as claimed in claim 16 wherein at least one hollow leg is secured to the hollow cup by a locking device.

22. A modular component mobile support stand as claimed in claim 21 wherein the locking device is a pin inserted through the hollow leg and the hollow cup.

23. A modular component mobile support stand as claimed in claim 1 wherein each of the legs is permanently attached to the base member.

24. A modular component mobile support stand as claimed in claim 23 wherein the permanent attachment is welding.

25. A modular component mobile support stand as claimed in claim 23 wherein the permanent attachment is gluing.

26. A modular component mobile support stand as claimed in claim 1 wherein the lattice has a total length of from about two feet to about 58 inches.

27. A modular component mobile support stand as claimed in claim 26 wherein the length can be adjusted up or down.

28. A modular component mobile support stand as claimed in claim 27 wherein the means for adjusting the length is pneumatic.

29. A modular component mobile support stand as claimed in claim 27 wherein the means for adjusting the length includes elastic bands.

30. A modular component mobile support stand as claimed in claim 27 wherein the means for adjusting the length includes a series of openings located vertically in the legs that are aligned from leg to leg, and there are removable supports in the openings.

31. A modular component mobile support stand as claimed in claim 27 wherein the means for adjusting the length includes providing interchangeable legs of varying lengths.

27. A modular component mobile support stand as claimed in claim 1 wherein each cantilevered support member has a near end, the near end having an extension mounted thereon by one end, said extension terminating in an L-shaped configuration, said L-shaped configuration having an inside surface, the L portion of the extension having a tooth centered on the inside surface.

28. A modular component mobile support stand as claimed in claim 27 wherein the cantilevered support member has a top surface and, in addition, there is present a pivoting cam located at the junction of the near end of the cantilevered support member and the attachment of the L-shaped configuration and on the top surface of the cantilevered support member.

29. A modular component mobile support stand as claimed in claim 1 wherein the legs of the lattice are enclosed in a casing.

30. A modular component mobile support stand as claimed in claim 29 wherein the casing is comprised of two front fascia panels and a rear fascia panel.

31. A modular component mobile support stand as claimed in claim 29 wherein the casing is comprised of one unitary front fascia panel and a rear fascia panel.

32. A modular component mobile support stand as claimed in claim 29 wherein there is a column separating the two front fascia panels and there is positioned between the two front fascia panels, a third leg, which leg has disposed therein, accessible outlets selected from the group consisting of electrical outlets and electronic outlets.

33. In combination, A modular component mobile support stand as claimed in claim 1 and at least one accessory.

34. The combination as claimed in claim 33 wherein the accessory is modular.

35. A modular component mobile support stand as claimed in claim 34 wherein the module is selected from the group consisting of:

| | | | | | |
|---|---|---|---|---|---|
| (i) | desk top, | (ii) | personal computer, | (iii) | film |
| | | | | | projector, |
| (iv) | slide projector, | (iv) | television, | (v) | DVD player, |
| (vi) | tape recorder, | (vii) | overhead projector | (viii) | cupboard, |
| (ix) | typewriter, | (x) | keyboard, | (xi) | bookshelf, |
| (xii) | power pack | (xiii) | printer, | (xiv) | scanner, |
| (xv) | lighting, and, | (xvi) | any combination of | | |
| | | | (i) to (xv). | | |

36. A base for a modular component mobile support stand, the base comprising: an essentially U-shaped main cross bar to which is attached two forward extending support legs, wherein the each of the forward extending support legs has a front end and a back end and the back ends are attached to the U-shaped main cross bar.

37. The base as claimed in claim 36 wherein the front ends of the forward extending support legs are spaced apart from each other a greater distance that the back ends of the forward extending support legs are spaced from each other.

38. The base as claimed in 36 that is supported by four transport devices.

39. The base as claimed in claim 38 wherein the four transport devices are rotatable wheels.

40. The base as claimed in claim 38 wherein the four transport devices are rotatable casters.

41. The base as claimed in claim 39 wherein the rotatable wheels are lockable.

42. The base as claimed in claim 42 wherein the rotatable castors are lockable.

43. The base as claimed in claim 38 wherein the four transport devices are glides.

44. The base as claimed in claim 39 wherein each of the rotatable wheels is surmounted by a bumper disk.

45. The base as claimed in claim 40 wherein each of the rotatable castors is surmounted by a bumper disk.

46. A cantilevered support member, said cantilevered support member having a near end, the near end having an extension mounted thereon, said extension terminating in an L-shaped configuration, said L-shaped configuration having an inside surface, the L portion of the extension having a tooth centered on the inside surface.

47. A cantilevered support member as claimed in claim 46 wherein the cantilevered support member has a top surface and, in addition, there is present a pivoting cam located at the junction of the near end of the cantilevered support member and the attachment of the L-shaped configuration and on the top surface of the cantilevered support member.

48. A kit, said kit comprising:
a. a base member;
b. four transport devices;
c. four bumper disks;
d. a vertical lattice;
e. at least two cantilever support members, and,
f. at least one accessory module selected from the group consisting of:

| | | | | | |
|---|---|---|---|---|---|
| (i) | desk top, | (ii) | personal computer, | (iii) | film projector, |
| (iv) | slide projector, | (iv) | television, | (v) | DVD player, |
| (vi) | tape recorder, | (vii) | overhead projector | (viii) | cupboard, |
| (ix) | typewriter, | (x) | keyboard, | (xi) | bookshelf, |
| (xii) | power pack | (xiii) | printer, | (xiv) | scanner, |
| (xv) | lighting, | (xvi) | simple platforms, | (xvii) | video screens, |
| (xviii) | flat monitor brackets, | (xix) | hanging file storage, | (xx) | audio/visual |
| | storage and transporting, | (xxi) | health care appliances; | (xxii) | mobile laptop |
| | work desks, | (xxiii) | seating, | (xxiv) | podiums, |
| (xxv) | electrical accessories, | (xxvi) | power sources, | (xxvii) | power strips, |
| (xxviii) | data strips, | (xxix) | cord management, | | |
| (xxx) | paper management trays, | (xxxi) | wireless data transmitters, | (xxxii) | wireless |
| | | | | | data receivers, and |
| | | | | | any combination of |
| | | | | | (i) to (xxxii). |
